(19) United States
(12) Patent Application Publication
(10) Pub. No.: US 2008/0300732 A1
(43) Pub. Date: Dec. 4, 2008

(54) Bus Communication Management in a Motor Vehicle with a Plurality of Control Devices Linked by a Bus and Method of Controlling the Bus Communication Management

(75) Inventors: Dietmar Luz, Calw (DE); Rudiger Roppel, Flieden (DE)

Correspondence Address: LERNER GREENBERG STEMER LLP, P O BOX 2480, HOLLYWOOD, FL, 33022-2480, US

(73) Assignee: DR. ING. H.C. F. PORSCHE AG, Weissach (DE)

(21) Appl. No.: 12/191,014

(22) Filed: Aug. 13, 2008

Related U.S. Application Data
(63) Continuation of application No. PCT/EP2007/007441, filed on Aug. 24, 2007.

(30) Foreign Application Priority Data
Aug. 29, 2006 (DE) 10 2006 040 442.4

(51) Int. Cl. G06F 17/00

(52) U.S. Cl. 701/1

(57) ABSTRACT

An apparatus for a motor vehicle includes a first control device, a plurality of second control devices, and a bus system that links the control devices. Wherewith an activity of the control devices is dependent on communication between the control devices which is transmitted via the bus system. The apparatus is distinguished in that the first control device is configured such as to deny communication to (or via) the bus system under prescribed conditions, and the second control devices are configured to cancel (interrupt) a communication to (or via) the bus system if the first control device denies the communication. Additionally, a method is disclosed wherein the apparatus is operated in the described manner.

### CROSS-REFERENCE TO RELATED APPLICATIONS

This is a continuing application, under 35 U.S.C. § 120, of copending international application No. PCT/EP2007/007441, filed Aug. 24, 2007, which designated the United States; this application also claims the priority, under 35 U.S.C. § 119, of German patent application No. DE 10 2006 040 442.4, filed Aug. 29, 2006; the prior applications are herewith incorporated by reference in their entirety.

### BACKGROUND OF THE INVENTION

### Field of the Invention

The invention relates to an apparatus for an motor vehicle formed of a first control device, a plurality of second control devices, and a bus system which links the control devices. Wherewith an activity of the control devices depends on a communication between the control devices which is transmitted via the bus system. Such apparatuses and processes are known in various embodiments in motor vehicles.

Modern motor vehicles generally have numerous control devices that are interlinked (in a network) via a bus system. The control devices may be associated with, e.g., comfort electronics, information and entertainment systems, engine and drive train control, chassis and suspension system controls, braking control, and safety functions such as crash anticipation. A typical present-day vehicle will have a total number of such control devices in the range of 10-100, and this number is rising.

The overall current draw of all control devices in a contemporary motor vehicle may amount to several Amps, not even including current drawn by control devices in end stage functions of control of electric motors and other actuators. In normal vehicle operation (with the engine in operation), the electricity requirements of these devices can be easily met by the generator that is driven by the internal combustion engine of the vehicle. When the engine is at rest (turned off), however, the power demands can lead to rapid discharging of the storage battery or the like. If the interval between engine starts is substantial, the battery drain can appreciably weaken the ability to start the vehicle.

Thus, the starting ability (vehicle availability) is affected above all by the electricity consumption in the at rest state.

Each activation of control devices by (or from) the bus system is associated with additional electricity consumption.

In order to reduce electricity consumption in the at rest state, measures are employed to appreciably reduce the consumptive activity of the control devices during periods when the vehicle is in the rest state. For purposes of understanding the invention, it suffices to differentiate an active control device (control device in an activated state) from an inactive control device. Current at a minimal level is drawn by a control device even in its so-called inactive (not activated) state, e.g. to avoid loss of stored data. Hereinafter, an inactive control device may alternatively be referred to also as a control device in sleep mode.

In order to ensure the availability of the vehicle, in particular the ability to undergo energy-intensive starting of the engine even after long periods at rest (with engine turned off), limiting values of electricity consumption in the at rest state must be adhered to. A typical such limiting value is two orders of magnitude below the current draw of all control devices in the active state. Thus if all control devices taken together have a current draw of 5 A in the active state, then in the sleep mode the total current draw should not exceed 50 mA.

When the motor vehicle is put in the at rest mode, routines are carried out in the control devices whereby the control devices and bus system are switched into the sleep mode, with substantially lower power consumption. If a battery has a capacity of 70 Ampere-hours, one may calculate by simple arithmetic that, e.g., it can suffer a draw of 50 mA for more than 1000 hours and still have residual capacity 20 Ampere-hours.

An underlying assumption here is that the complex system formed of a few dozens control devices linked by a bus system can be completely switched into the supposed sleep mode without problems. Such networked systems in vehicles are somewhat complex aggregates with a large number of functions, each of which functions is associated with one or more particular control devices. As the number of elements of the network is increased, complexity is increased, and the need for a robust communication configuration becomes more acute, particularly robustness against unwanted communication exchanges (activation of the bus system) and robustness to ensure reliable return to the starting state (bus in sleep mode).

If one or more control devices persists in the active state as a result of a malfunction, this will lead to increased power consumption and thus to accelerated depletion of the charge of the vehicle battery. Consequently, the duration of an at rest phase over which the vehicle engine can be restarted without problems will be decreased. In other words, such a malfunction may cause the period of availability of the vehicle to the driver to become significantly limited.

### BRIEF SUMMARY OF THE INVENTION

It is accordingly an object of the invention to provide bus communication management in a motor vehicle with a plurality of control devices linked by a bus and a method of controlling the bus communication management that overcomes the above-mentioned disadvantages of the prior art devices and methods of this general type, which are capable of eliminating or at least reducing the drawback of limited availability.

With the foregoing and other objects in view there is provided, in accordance with the invention, an apparatus for a motor vehicle. The apparatus contains control devices including a first control device and a plurality of second control devices and a bus system interconnecting the control devices. An activity of the control devices is dependent on a communication between the control devices transmitted via the bus system. The first control device is configured to deny the communication to the bus system under prescribed conditions, and the second control devices are configured to interrupt the communication to the bus system if the first control device denies the communication.

The invention confronts the fact that, as a result of the networking of the control devices, a primary malfunction can have as a consequence (secondary malfunction) that one or more control devices can be active when they should be in the sleep mode.

Such secondary malfunctions come about because of the so-called wakeability of the control devices, namely the characteristic of a control device that it can be switched from the sleep mode to the active state by a wakeup event (wakening event), under the auspices of another control device. A wakeup event (wakening event) is defined as an input-side signal exchange at a control device interface, which signal exchange leads to local waking up of the control device, wherewith such a signal exchange can propagate via communication interfaces to the adjoining bus segment. Thus a distinction is made between local wakeup events which are confined to the interior of a control device and bus-involving wakeup events which are external to the given control device.

In the discussion herein below, the wakeup events considered will be those which can lead to waking up of an adjoining bus segment, and which, depending on the resulting communications involvement, can lead to waking up of other bus segments.

Wakeability is a necessity in certain functions of current motor vehicles, in order to enable communication between control devices even when the vehicle is in an at rest state. External wakeup events lead, via a signal at an interrupt-susceptible input, to local activation (or increase in the activity) of a control device. Depending on the relevance of the signal for the rest of the system, wakening signals may be propagated to and in the bus system and possibly to other control devices. If the bus system is woken up, the adjoining control devices will be activated (or have their activities increased). If none of the control devices requires operation of a bus segment, then the bus system will immediately return to the sleep mode, and the control devices that have been activated will also return to the sleep mode. If, e.g., a locked motor vehicle is opened by remote control, a number of control devices will be involved: a door control device (door lock control device) will wake up the bus system, and, via the bus system, an onboard mains control device which serves to turn on the cabin lights will be woken up.

Thus a control device that is active as a result of a primary malfunction can cause other control devices to remain active or to be activated (woken up); this is referred to as a consequential malfunction or secondary malfunction. The current draw is then increased not only in the control device suffering the primary malfunction but also in all control devices suffering the so-called secondary malfunctions. According to the invention, a communication to (or on) the bus system is denied under prescribed conditions; this allows one to avoid undesired wakening or maintenance of activation of additional control devices which would otherwise occur as a consequence of the primary malfunction. Thus, with application of the invention, the increased current draw which occurs in the event of a primary malfunction in a given control device does not extend beyond that control device.

In accordance with an added feature of invention, one of the prescribed conditions is that the motor vehicle is in an at rest state.

In accordance with another feature of the invention, the first control device is configured such that in an instance where the communication to the bus system is maintained by a respective one of the second control devices which respective second control device is active as a result of a malfunction, the first control device sends a force shutdown control command to the second control devices. The second control devices are configured such that the second control devices respond to receipt of the force shutdown control command by interrupting the communication to the bus system. Ideally, the second control devices are configured such that, upon receipt of the force shutdown control command, the second control devices enter a sleep mode characterized by reduced activity.

In accordance with a further feature of the invention, the second control devices are capable of being woken up, and that the first control device is configured such that, in an event of repeated wakeup signals sought to be sent from a respective one of the second control devices in a sleep mode via the bus system to at least one other of the second control devices susceptible of being woken up, the first control device sends a prevent wakeup control command to the respective second control device which is sending the wakeup signals, and the respective second control device is configured such that it responds to receipt of the prevent wakeup control command by interrupting a sending of the wakeup signals.

With the foregoing and other objects in view there is provided, in accordance with the invention, a method for operating control devices of a motor vehicle including a first control device and a plurality of second control devices, and for operating a bus system linking the first and second control devices. An activity of the control devices is dependent on communication between the control devices transmitted via the bus system. The method includes the steps of checking via, the first control device, if at least one prescribed condition is fulfilled; denying, via the first control device, a communication to the bus system if a determination is positive during the checking step; and when the first control device denies the communication, interrupting via the second control devices the communication to the bus system.

In accordance with an added mode of the invention, there is the step of checking via the first control device, as the prescribed condition, whether the motor vehicle is in an at rest state.

In accordance with a further mode of the invention, in an instance where a communication to the bus system is maintained by a second control device which is active as a result of a malfunction, there is the step of sending via the first control device a force shutdown control command to the second control devices, and the second control devices respond to receipt of the force shutdown control command by canceling the communication to the bus system. The second control devices, upon receipt of the force shutdown control command, enter a sleep mode characterized by reduced activity. In an event of repeated wakeup signals sought to be sent from a respective one of the second control devices in a sleep mode via the bus system to at least one other of the second control devices susceptible of being woken up, there is the step of sending via the first control device a prevent wakeup control command to the respective second control device which is sending the wakeup signals, and the respective second control device responds to receipt of the prevent wakeup control command by interrupting the sending of the wakeup signals.

Other features which are considered as characteristic for the invention are set forth in the appended claims.

Although the invention is illustrated and described herein as embodied in bus communication management in a motor vehicle with a plurality of control devices linked by a bus and a method of controlling the bus communication management, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of an apparatus formed of a first control device, a plurality of second control devices, and a bus system linking the control devices according to the invention;

FIG. 2 is a functional block diagram of a second control device; and

FIGS. 3A and 3B are flow diagrams offered as an exemplary embodiment of an inventive method.

### DETAILED DESCRIPTION OF THE INVENTION

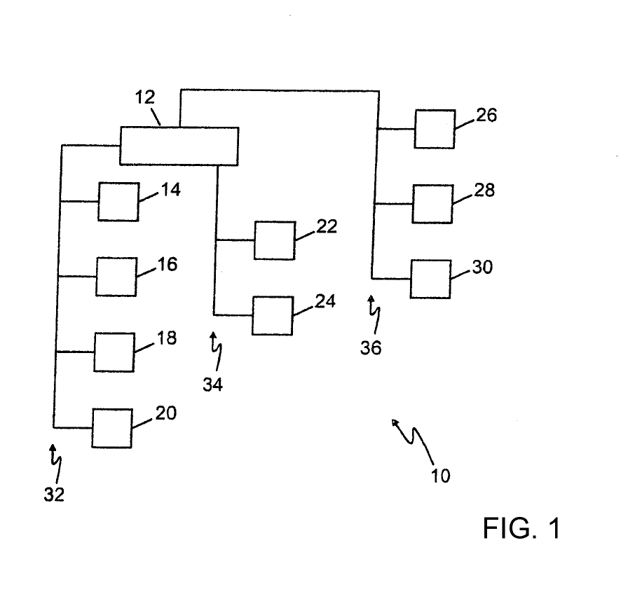

Referring now to the figures of the drawing in detail and first, particularly, to FIG. 1 thereof, there is shown an apparatus 10 for a motor vehicle, formed of a plurality of control devices 12, 14, 16, 18, 20, 22, 24, 26, 28, 30 and a bus system 32, 34, 36 which connects all of the control devices. The control devices 14, 16, 18, 20 as depicted in FIG. 1 are associated with control of a drive train, and are connected to a drive train bus segment 32. Examples of such control devices 14, 16, 18, 20 are control devices for ignition and/or fuel injection and/or variable valve control, and control devices for the transmission (or for transmission components). Examples of control devices 22, 24 are control devices for information and entertainment functions, e.g. for navigation systems and audio devices; these control devices are connected to an information and entertainment bus segment 34. Examples of control devices 26, 28, 30 as shown in FIG. 1 are control devices for comfort functions, e.g. for control of windows, and remote opening and locking of doors; these control devices are connected to a comfort bus segment 36.

In the embodiment according to FIG. 1, the bus segments 32, 34, 36 are interconnected by a control device 12 which serves as a gateway control device. Thus, data exchange between individual bus segments takes place via the gateway control device 12. In this way, individual bus segments can operate with different data transfer speeds that are adjusted to their functions. Information exchanged only between control devices in a given bus segment does not interfere with other bus segments. Information which is required not only locally on a given source bus segment is further transmitted to a target bus segment via the gateway control device 12; this transmission process is also known as routing. In connection with routing, the gateway control device 12 carries out adjustments that may be necessary to coordinate different data transfer protocols that may be operative on different bus segments.

When the vehicle is at rest, e.g. with engine ignition turned off, the target bus segment for information is dormant, as a rule. Also under these circumstances, the gateway control device 12 or another control device in the bus system takes over the role of power master; namely, after a wakeup process occurs in a source bus segment, the power master serves to activate (wake up) the target bus segment. After such a wakeup event, the gateway control device 12 maintains the thus woken up bus segment in an active status for a prescribed time, thereby enabling communication between control devices in the source bus segment and control devices in the target bus segment.

Let us assume that the control device 26 is a door lock control device, wherewith, when the vehicle is at rest and locked, the device 26 can be woken up by a signal from a functional control, for controlling the door locks. Further, assume that control device 14 is a motor control device that controls, inter alia, an electric fuel pump. In this case, the door lock control device 26 will activate (wake up) the comfort bus segment 36, and under circumstances of a thus activated comfort bus segment 36 the gateway control device 12 will wake up the drive train bus segment 32, thereby enabling communication between the door control device 26 and the motor control device 14. The door control device 26 notifies the motor control device 14 concerning the door opening, and the motor control device 14 will react by sending a control signal to the electric fuel pump (in an embodiment in which this is called for) which will ensure that at the appropriate time sufficient fuel pressure will be available to promptly start the vehicle engine.

If engine starting does not eventuate, e.g. because the vehicle ignition is subsequently shut off, then in situations in which some other problem is not present the apparatus will return to an at rest state, in which all control devices and bus segments are in a sleep mode, with minimum power consumption.

A malfunction or other problem may be present in a control device, e.g. the abovementioned door control device 26, which will cause the device to fail to return to the sleep mode, wherewith the device will remain in the active state and will continually actively communicate with other control devices via the bus system 32, 34, 36 and the gateway control device 12, thereby causing these control devices and the participating buses to remain in an active state. This type of malfunction will be referred to herein below as a malfunction of the first type. When the control device 26 remains in the activated state with active bus communication, the result will be undue electric power drain, unless suitable countermeasures are in effect.

In the presence of a malfunction of a second type (malfunction of the second type), a control device, e.g. the abovementioned door control device 26, will be switched into the sleep mode, but, as a result of an internal malfunction or other problem, it will in fact remain active or will reactivate, so that the adjoining bus segment (and possibly other bus segments and control devices) will be continually woken up by wakeup events associated with the malfunctioning control device.

Both types of malfunction lead to disturbance of the desired idle condition (sleep mode) of the bus. In both cases the electric power consumption is unduly increased while the vehicle is at rest, not only from the power consumption of the malfunctioning control device but also from the power consumption of all other unnecessarily active and/or unnecessarily woken up control devices.

This drawback is avoided by the inventive apparatus in that a first control device is configured to deny communications to the bus system 32, 34, 36 under prescribed conditions, and a second control device is configured to cancel (interrupt) a communication to the bus if the first control device denies that communication. It should be understood that the embodiment with the door control device is offered solely for purposes of example, and does not limit the scope of the invention; and, further, that the invention can influence communications between any control devices, particularly between a plurality of any number of control devices which are linked by the bus system. The first control device is preferably the gateway control device 12 which in this respect has a master functionality for additional specialized functions to ensure the sleep mode of the bus under conditions of a malfunction of a given second control device. This increases the fault-tolerance of the bus system. Candidates for such a second control device are any of the customary control devices 14, 16, 18, 20, 22, 24, 26, 28, 30. In the above-presented example of a malfunctioning door control device 26, the device 26 is a typical representative of a second control device.

The specialized functions include in particular a force shutdown function and a prevent wakeup function. The force shutdown function interrupts (blocks) a communication between one control device and other control devices which communication is in existence and is sought to be transmitted via the bus system. The prevent wakeup function prevents the control device from the very initiation of a communication with other control devices which communication if initiated would be sought to be transmitted via the bus system. The specialized functions serve to prevent the effects of a malfunction in a second control device 26 from propagating to other second control devices 14, 16, 18, 20, 22, 24, 28, 30. The first control device 12, as the master control device, centrally performs the necessary monitoring of the sleep mode of the bus, and evaluation of disturbances of the sleep mode, which monitoring and evaluation are necessary in order to bring into being (activate) the specialized functions. In the event of a disturbance of the sleep mode, the first control device 12 will command all of the second control devices 14, 16, 18, 20, 22, 24, 26, 28, 30, or particular second control devices (e.g. 26) (depending on the particular malfunction), to initiate specialized functions. For the sake of increasing the robustness, it is advantageous if all activatable (wakeable) second control devices 14, 16, 18, 20; 22, 24; 26, 28, 30 connected to a given bus segment 32; 34; 36 are provided with the specialized functions. When the ignition system is turned on, the specialized functions become irrelevant, because under those circumstances all of the bus segments 32, 34, 36 are automatically and intentionally active, and thus the concept of disturbance of the sleep mode is irrelevant.

The control device 12 is configured so as to deny communication via the bus system 32, 34, 36 under prescribed conditions. In this connection, preferably the first control device 12 checks whether the motor vehicle is in an at rest state. It recognizes an at rest state by the fact that the vehicle engine is not operating or that (in addition) the ignition system is turned off.

In addition, a plausibilization is carried out concerning the behavior of the second control devices 14, 16, 18, 20, 22, 24, 26, 28, 30, for which various techniques may be used. This plausibilization may be on the basis of, e.g., time. In a system in which such a time-based plausibilization is implemented, the first control device 12 determines whether the second control devices 14, 16, 18, 20, 22, 24, 26, 28, 30 enter the sleep mode within prescribed time intervals after the vehicle enters an at rest state. If a second control device (e.g. 26) continues to send communications to other control devices 14, 16, 18, 20, 22, 24, 28, 30 via the bus system 32, 34, 36, this indicates that this second control device 26 has a malfunction of the first type. In this instance, the first control device 12 will send a force shutdown control command to the malfunctioning second control device 26 as well as (possibly) to other second control devices 14, 16, 18, 20, 22, 24, 28, 30, shifting this/these control device(s) into the sleep mode.

According to a particular embodiment, the other second control devices 14, 16, 18, 20, 22, 24, 28, 30 are configured such that upon receiving a force shutdown control command they will shift into a minimal-activity sleep mode. The first control device 12 detects the presence of a malfunction of the second type by monitoring the control devices connected to the bus segments, wherewith the system behavior is evaluated on the basis of, e.g., the number of wakeup events per unit time.

If a second control device (e.g. 26) has a malfunction of the second type, the malfunction will manifest itself as a high frequency of wakeup events. According to a particular embodiment, in this instance the first control device 12 will send a prevent wakeup control command to the offending second control device 26, which prevents the control device 26 from initiating communications with other control devices.

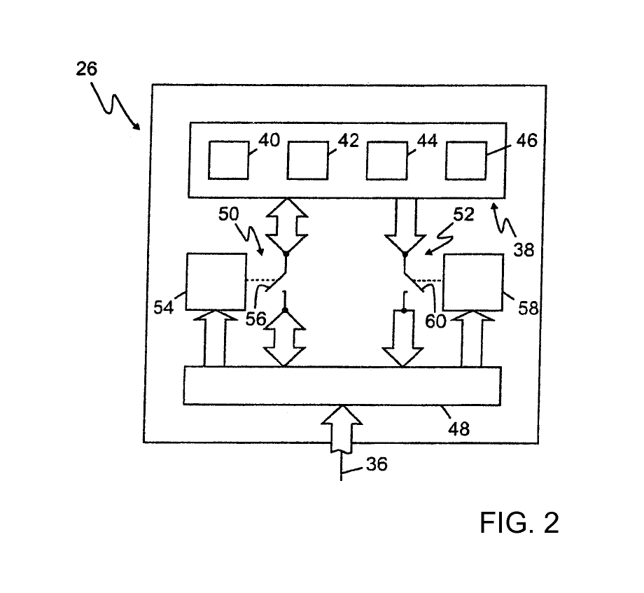

FIG. 2 is a function structure diagram for the door control device 26 (as a representative of a second control device 14, 16, 18, 20, 22, 24, 26, 28, 30. The second control device 26 has an application layer 38 with software modules 40-46 which modules 40-46 serve to realize the control functions which the control device 26 is supposed to implement when the vehicle is in operation or is in the at rest state. A communication layer 48, preferably also realized as a software module, facilitates communication of the application layer 38 with other control devices 14, 16, 18, 20, 22, 24, 28, 30 via the associated bus segment 36 of the bus system 32, 34, 36. In the context of such communication, there may occur, e.g., data exchange, illustrated in FIG. 2 by a data transmission link 50. When the communication layer 48 is active, and a link (or links) to one or more other control devices 14, 16, 18, 20, 22, 24, 28, 30 has/have been established and are operative, then the transmission link 50 is active.

The application layer 38 and the communication layer 48 should be devised and programmed such that they can operate mutually independently.

If a malfunction of the first type is present, the control device 26 persists in an active state with the application layer 38 active, and thus the control device 26 maintains communications with other control devices 12, 14, 16, 18, 20, 22, 24, 28, 30, thereby preventing these other control devices from entering the sleep mode.

Further, the application level 38 can send wakeup signals to other second control devices 14, 16, 18, 20, 22, 24, 28, 30 via the wakeup link 52. If a malfunction of the second type is present, wakeup signals transmitted via the wakeup link 52 will wake up the specific other second control devices 14, 16, 18, 20, 22, 24, 28, 30 and bus segments 32, 34, 36.

The second control device 26 is also configured to cancel (interrupt) a communication to the bus system 32, 34, 36 if the first control device 12 denies the communication. In this instance, the second control device 26 will receive a specific control command from the first control device 12.

If the control command is a force shutdown control command, a force shutdown module 54 will react to receipt of the force shutdown control command by canceling (interrupting) the data transmission (via the data transmission link 50) between the application layer 38 and the communication layer 48. In FIG. 2 this is represented symbolically by the open switch 56. As a result, the application layer 38 which has offended by sending the communication is disconnected from the communication layer 48 and thus from the bus system 32, 34, 36. The application layer 38 is still free to operate in a self-contained mode. Meanwhile, the bus system 32, 34, 36 will not be transmitting any messages from the offending application layer 48 in the second control device 26 to other second control devices 14, 16, 18, 20, 22, 24, 28, 30; consequently these are free to enter sleep mode, which mode is characterized by minimal power consumption.

Stated differently: if the bus system 32, 34, 36 does not behave in accordance with prescribed instructions, and fails to enter bus sleep mode at prescribed query time points after the ignition system is turned off, the force shutdown special function allows the bus system to ignore the offending application layer 38 of the second control device 26. As a result of this non-acquiescence, the other second control devices 14, 16, 18, 20, 22, 24, 28, 30 can enter the sleep mode (either by command or automatically). The force shutdown special function thus allows the other second control devices 14, 16, 18, 20, 22, 24, 28, 30 to enter the sleep mode, and this leads to the desired sleep mode of the bus system and to reduction of the otherwise much larger power consumption of the vehicle.

If the control command is a prevent wakeup control command, a prevent wakeup software module 58 will react to receipt of the prevent wakeup control command by interrupting the wakeup link 52 between the application layer 38 and the communication layer 48. In FIG. 2 this is represented symbolically by the open switch 60. Stated differently: in the second control device 26 an intermediate layer 58 must be implemented which can control wakeup events from the application layer 38 and which can be actuated directly by the prevent wakeup control command.

As mentioned, it may be necessary for a bus segment 32, 34, 36 to be woken up by a second control device 26 in order to be able to transmit relevant information to other second control devices 14, 16, 18, 20, 22, 24, 28, 30. However, in the event of a malfunction, a malfunction in a second control device 26 may result in continual waking of the adjoining bus segment 36 by wakeup events. The first control device 12 evaluates these wakeup events and can as a result make the determination to implement active suppression of the wakeup sources and/or wakeup events of individual second control devices 26 connected to the bus system 32, 34, 36.

Preferably, the evaluation of the wakeup events is initiated when the ignition is turned off and the key is withdrawn (terminal S is disengaged), and the vehicle is locked. As a result, the wakeup processes needed in a shutoff are not intentionally ignored. When undesired or malfunction-related behavior of the wakeup processes is detected, a prevent wakeup control command is sent. Preferably, the bus system 32, 34, 36 is not specifically woken up on the occasion of the sending of the prevent wakeup control command, but rather this command is sent at a time that the bus system 32, 34, 36 is waked up by another bus client.

When the prevent wakeup special function of a second control device 26 is activated, it must still be possible for this device to be woken up via the bus (CAN wakeup). The status of the function is preferably stored internally, after activation or after deactivation, in a nonvolatile memory. In the initialization phase of the second control device 26, the current state is read from the memory, and when prevent wakeup is active the corresponding restrictions are implemented such that the bus system 32, 34, 36 is not waked up.

After the prevent wakeup control command is sent, the second control devices concerned 26 will no longer be able to wake up the bus.

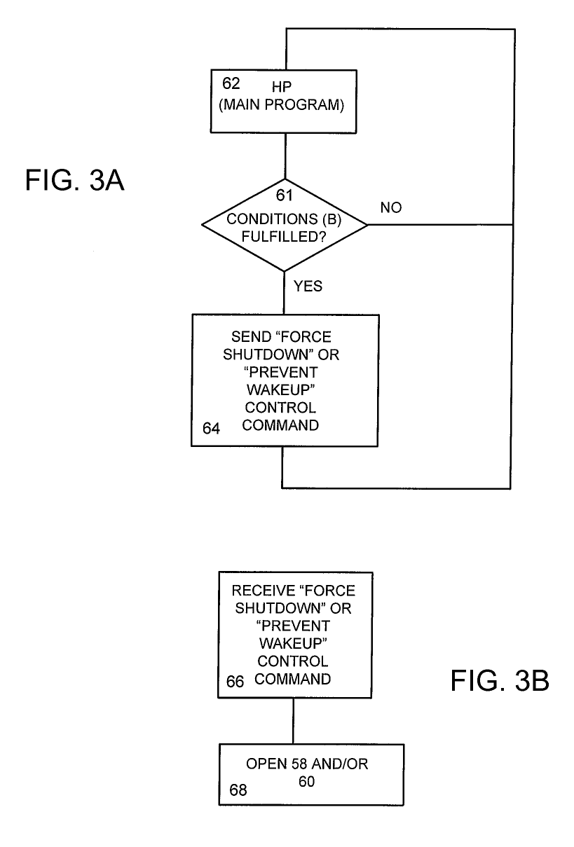

FIGS. 3A and 3B are process diagrams illustrating an exemplary embodiment of an inventive process. In particular, FIG. 3A relates to a partial process carried out in the first control device 12, and FIG. 3B relates to a partial process carried out in one of the second control devices 14, 16, 18, 20, 22, 24, 26, 28, 30.

In step 61 of FIG. 3A, which step is arrived at from a superordinated main program (HP) 62, the first control device 12 checks whether conditions B are fulfilled under which communications to the bus system 32, 34, 36 should be denied. As mentioned, in this context the device 12 at least checks whether the motor vehicle is in the rest state with its engine not operating and its ignition shut off. If in step 61 the device 12 detects impermissible activity associated with a malfunction of the first type or a malfunction of the second type, then in a step 64 the device 12 will send the described force shutdown control command and/or prevent wakeup control command.

In step 66 (FIG. 3B), carried out on one or more second control devices 14, 16, 18, 20, 22, 24, 26, 28, 30, a force shutdown control command and/or a prevent wakeup control command is received, and in a further step 68 a switch 56 and/or 60 is/are caused to open.

1. An apparatus for a motor vehicle, comprising:
control devices including a first control device and a plurality of second control devices;
a bus system interconnecting said control devices, an activity of said control devices being dependent on a communication between said control devices transmitted via said bus system; and
said first control device configured to deny the communication to said bus system under prescribed conditions, and said second control devices configured to interrupt the communication to said bus system if said first control device denies the communication.

2. The apparatus according to claim 1, wherein one of said prescribed conditions is that the motor vehicle is in an at rest state.

3. The apparatus according to claim 1, wherein said first control device is configured such that in an instance where the communication to the bus system is maintained by a respective one of said second control devices which said respective second control device is active as a result of a malfunction, said first control device sends a force shutdown control command to said second control devices, and said second control devices are configured such that said second control devices respond to receipt of the force shutdown control command by interrupting the communication to the bus system.

4. The apparatus according to claim 3, wherein said second control devices are configured such that, upon receipt of the force shutdown control command, said second control devices enter a sleep mode characterized by reduced activity.

5. The apparatus according to claim 2, wherein said second control devices are capable of being woken up, and that said first control device is configured such that, in an event of repeated wakeup signals sought to be sent from a respective one of said second control devices in a sleep mode via said bus system to at least one other of said second control devices susceptible of being woken up, said first control device sends a prevent wakeup control command to said respective second control device which is sending the wakeup signals, and said respective second control device is configured such that it responds to receipt of the prevent wakeup control command by interrupting a sending of the wakeup signals.

6. A method for operating control devices of a motor vehicle including a first control device and a plurality of second control devices, and for operating a bus system linking the first and second control devices, an activity of the control devices being dependent on communication between the control devices transmitted via the bus system, the method comprising the steps of:
checking via, the first control device, if at least one prescribed condition is fulfilled;
denying, via the first control device, a communication to the bus system if a determination is positive during the checking step; and
when the first control device denies the communication, interrupting via the second control devices the communication to the bus system.

7. The method according to claim 6, which further comprises checking via the first control device, as the prescribed condition, whether the motor vehicle is in an at rest state.

8. The method according to claim 6, wherein in an instance where a communication to the bus system is maintained by a second control device which is active as a result of a malfunction, sending via the first control device a force shutdown control command to the second control devices, and the second control devices respond to receipt of the force shutdown control command by canceling the communication to the bus system.

9. The method according to claim 8, wherein the second control devices, upon receipt of the force shutdown control command, enter a sleep mode characterized by reduced activity.

10. The method according to claim 7, wherein in an event of repeated wakeup signals sought to be sent from a respective one of the second control devices in a sleep mode via the bus system to at least one other of the second control devices susceptible of being woken up, sending via the first control device a prevent wakeup control command to the respective second control device which is sending the wakeup signals, and the respective second control device responds to receipt of the prevent wakeup control command by interrupting the sending of the wakeup signals.
